(19) United States
(12) Patent Application Publication
(10) Pub. No.: US 2009/0187626 A1
(43) Pub. Date: Jul. 23, 2009

(54) INTERACTIVE INTELLIGENT SYSTEM AND METHOD FOR INFORMATION MANAGEMENT

(76) Inventor: Fabien Degaugue, Templeuve (FR)

Correspondence Address: LADAS & PARRY LLP, 224 SOUTH MICHIGAN AVENUE, SUITE 1600, CHICAGO, IL, 60604, US

(21) Appl. No.: 11/576,158

(22) PCT Filed: Sep. 28, 2005
(86) PCT No.: PCT/FR05/02402

§ 371 Date: Mar. 28, 2007

(30) Foreign Application Priority Data
Sep. 28, 2004 (FR) 0410269

(51) Int. Cl. G06F 15/16

(52) U.S. Cl. 709/205

(57) ABSTRACT

An intelligent interactive, system and method for information management in a communication network. The system is used, in particular, for interest easily-upgradeable interactive systems, electronic e-mail systems and instant messaging systems, or any other communication means. The method and system bring together a set of participants which can be senders and/or recipients, in a communication network. The method includes providing the participant community with initial information by a sender participant, receiving information by other participants, determining a compatibility value between the initial information and a potential recipient for all other participants, selecting at least one potential recipient according to the previously determined compatibility values and transmitting the initial information to each selected recipient. The determination of the respective compatibility values between the respective initial information and the other participants includes determining a using rate for each participant.

The subject of this present invention is an interactive, intelligent information management system and method, in a communication network connecting several participants. It is designed for application in the area of interactive Internet systems that are easy to develop, and electronic messaging systems.

In general, in such systems, the user communicates with the system through a series of interactions. This leads to changes in the content and behaviour of the system.

Many Web sites are interactive. In contrast to the static sites which allow the users only to consult the Web pages, an Interactive Web site allows its users to alter the content or the behaviour of the site.

In addition, electronic messaging systems allow any visitor in possession of an electronic address to send and receive electronic messages. The messages include a sender, one or more recipients, a subject and a content. The messages can contain one or more attachments, of all types.

The Interactive Web sites and the messaging systems provide the unique opportunity to connect users together around a given subject of discussion.

For example, on the Web, discussion forums allow visitors to exchange questions and answers. These are community spaces, grouped by theme and allowing virtual communities to exchange information in the form of discussions between visitors by means of sequential messages. All the contributions of the people who have “posted” a message (usually called a “post”) in a forum are saved, and some applications allow the execution of later searches in the discussions by keyword. Forums usually specialise in one area, and their use is free of charge.

Distribution lists are an example of the application of electronic messaging systems. They allow a community of people to send each other messages dealing with a given subject. For example, in a distribution list on the theme of cinema in France and characterised by two addresses (imaginary here), an “administrative” address for subscribing and unsubscribing, and an “active” address to which to send the messages, a person wishing to subscribe to this list must first send a message to the administrative address using a certain syntax (a special message corresponding to the request to subscribe and so indicated in the title or the body of the message). The distribution list will then return a message confirming registration (most of these distribution lists are free of charge). From then on, the administrative address will be used only for unsubscribing. If 99 other people perform the same subscription process, this will then result in 100 subscribers added to the list in all. When one of the subscribers sends a message to the “active” address of the list, this message is automatically forwarded, meaning that it is distributed, to the other subscribers. Any of the subscribers can reply to it by means of the list (and the reply is then also distributed to all the other subscribers), or directly to the personal messaging address of the subscriber who sent the original message. This is a simple and efficient resource for discussion of a theme between enthusiasts, by means of an electronic messaging system.

Some lists are also said to be “moderated”. One person receives the messages of the subscribers, and then decides whether or not to distribute them depending on their conformity to the ethical standards of the forum. Questions often arise when the subject discussed touches upon religion, politics, racism, etc.

One of the problems created by these interactive systems of previous design is their lack of reliability and the complexity of their use. In fact, sending a message with such systems is a bit like “throwing a bottle in the ocean”, in the hope that a visitor may be interested. Neither is any guarantee given regarding the time taken to reply.

Moreover, whether it be discussion forums or distribution lists, in order to participate, one has to know that they exist and their location on the Internet. Now there are innumerable thematic discussion forums, of varying efficiency, which have to be looked for by means of search engines in order to be found, with the additional difficulty that this presents and the additional time that must be devoted to it.

Indeed, these systems also necessitate many operations that are frequently the preserve of experts.

Finally, they have technical limitations, such as the number of subscribers to a distribution list or to a discussion forum, for example. In particular, if there is an excessive number of subscribers, the messages eventually become very confused, or become lost amongst each other, or they never find anybody wishing to reply. The moderator then becomes an essential element of the system.

One is also familiar with the previous design of applications of the intelligent system type, to bring together people capable of answering questions raised by other people. Publication WO0139017, for example, describes an interactive system for managing questions and answers between users and experts, in which a server routes the question to the right people using information supplied by the user in the question. In addition, publication WO0153970 describes a system and a method for bringing together requests for information and sources of information, based on the notion of information source profiles. The information source is able to specify, directly in its own profile, that it wishes to be sent all the questions on a given subject. Finally, publication WO9939279 describes an information system based on human resource profiles. In this system, the expert to whom a question is sent, and who has been selected in relation to the relevance of his expertise and/or the suitability values in his profile in relation to the question raised. Selection takes place in accordance with a scalar value arising from factors such as availability, cost, workload, experience, security level, performance, and level of satisfaction.

These applications, whether used on a general network such as the Internet or on a private network such as a company network for the management and sharing of knowledge, all have the drawback of not allowing for the rate of use. The consequence of this is the risk of continuous tying up of the best experts, to the detriment of the other users who are therefore neglected. This generally gives rise to an imbalance in the system to the extent that a user who potentially holds the reply to certain questions raised will not be called in proportion to his own use of the system as a sender and/or recipient of questions. This problem is particularly severe in the case of a system open to the public and available on the Internet and so involving several thousand or even several million users. If balance is not maintained, then the whole use of the system is called into question, since eventually the unbalance results in a loss of user interest, either because the latter only very rarely (if ever) receive relevant answers to their questions, or because they are too heavily used as experts, or any combination of these reasons.

More generally, the existing systems operate mainly on the basis of the notion of expertise determined from a user profile. On this principle, these systems are coping with a large number of potential recipients for a given piece of information, which can lead to saturation of the system, to excessive disruption of the potential recipients, combining to reduce the efficiency of these systems and eventually to a loss of interest on the part of the users.

There is therefore a need for an intelligent interactive system for the management of information, and of a method implemented by such a system, allowing its users to exchange information through any communication network, such as the Internet, or a private network, for example. Such a system should optimise the possible chances for a sender of an information item to obtain a reply of quality on the part of at least one potential recipient, while not excessively disrupting these potential recipients.

It is therefore the aim of the invention to respond to the aforementioned need, and to overcome the aforementioned drawbacks. To this end, according to a first aspect, the invention refers to a method for the management of information in a communication network connecting a collection of participants, who are also potential sources of information, and who can be senders and/or recipients of information, where this method in particular allows a balance to be maintained in the exchanges of information, which is fundamental to the correct operation and stability of the said method.

By communication network is meant not only a private computer network, an intranet, an extranet, or the Internet, but also a non-computer network composed by the grouping together of participants who communicate by any means of communication.

By a participant is meant not only a human participant but also an independent computer system designed to communicate information on the network to which it is connected, such as a database, for example, and more generally any potential information source designed to communicate over a certain information network as described above. The participant thus defined can therefore take turns as a sender of information and a recipient of information for example.

When a participant sends an information item in order to make it available to other participants so as to obtain one or more information items in return, the first information item will be described as original information, and the other will be described as return information, replies, or answers.

A participant can be a recipient of original information and a sender of return information, without ever being a sender of original information or recipient of a return information item (this will be the case of a database participant, for example).

Thus, the method allows a first sender to make an original information item available to the community of participants, by means of an interface, with this information being liable to be received by one or more other participants.

For each of the other participants, the method can also be used to determine a match value between the original information made available and the potential recipient participant. At least one of the potential recipient participants is selected according to the match values determined previously.

The method also allows the sending of the original information made available to each of the selected recipient participants.

The method is also characterised in that determination of the respective match values between the original information made available by the sending participant and the other participants includes, for each of these other participants, determination of the rate of use.

In an implementation variant, the method of the invention includes the creation of a dynamic participation list that includes the sending participant of the original information.

Preferably, any other participant selected and who has sent at least one return information item to the sending participant of the original information item is inserted into the dynamic participation list, unless it concerns another selected participant who cannot be a sender of original information or a recipient of return information (a database, for example).

In an implementation variant, each return information item sent by any of the other selected participants to the sending participant of the original information, is also sent to all the other participants appearing on the dynamic participation list.

The information items exchanged, and where appropriate the information items simply consulted (such as the content of “Web pages” visited or discussion threads read), can be archived in an information base. In this base, they are each then associated with the respective identifiers of their sender and their recipients.

In an implementation variant, certain participants can be grouped according to predetermined criteria into one or more participant categories, for which the return information items sent are not archived in the information base.

Preferably, determining the rate of use for a given participant includes determining the mean frequency of the making available of other original information by this participant in the course of a predetermined period, and determining the mean reception frequency of other original information items by this participant during a predetermined period.

In addition to determining the rate of use, determining the match value can include determining the value of one or more other selection criteria, such as an expertise and/or availability and/or satisfaction and/or reliability value.

Preferably, the match value is the average of the respective values of the selection criteria.

Also preferably, each selection criterion is assigned a weighting coefficient. The aforementioned average can then be weighted by these weighting coefficients.

Where appropriate, the participants for whom the previously determined match value is greater than a certain predetermined match threshold are selected.

Preferably, the reliability value is a function of the number of return information items sent and the number of original information items received.

Where appropriate selection can include calculation of the probability of no reply from the reliability values of each of the selected participants, considered in descending order of their respective match values, and then minimising the number of selected participants, considered in descending order of their respective match values, during which the minimum number of selected participants for whom the probability of no reply is less than a predetermined threshold are retained.

Preferably, the method allows the sending participant of an original information item and/or an administrator participant, to adjust some of the parameters for determining the match value.

The parameters for determining the said match value can include the threshold of probability of no reply and/or the maximum number of selectable participants and/or one or more of the weighting coefficients and/or the match threshold.

Preferably, when the latter forms part of the selection criteria, determining the expertise value of a selectable participant includes a semantic analysis of the original information made available by the sending participant, and a comparison of this semantic analysis with the contextual analysis of the information items archived in the information base concerning this selectable participant.

According to a second aspect, the invention relates to an intelligent interactive system for the management of information in a communication network connecting, by means of interfaces, a collection of participants who can be senders and/or recipients of information, and employing the method of the invention as described previously, where this system in particular allows a balance to be maintained in the exchanges of information, which is fundamental to the correct operation and stability of the said system.

Preferably, the system includes a means of determining the match value between an original information item, made available by a given sending participant, and another given participant, and includes a unit for the selection of at least one other participant according to the match values determined for each of the other participants. The resource for determining the match value also includes at least one module for determining the rate of use of this other given participant.

Preferably, this resource for determining the match value also includes, in addition to the module for determining the rate of use, at least one additional module for determining the value of at least one other selection criterion.

Finally, according to a third aspect, the invention relates to a computer-readable storage medium, on which is stored a sequence of instructions which, when it is executed by a computer system, allows the latter to implement the method according to the invention as described previously.

Thus, the system and the method according to the invention are advantageously used to solve the problems of previous design, by proposing a more reliable and less complex solution, through optimisation of the parameters so as to maximise the chances for a user to obtain a reply of quality to his question.

The system and the method according to the invention allow operation with a very large number of users while also reducing the risks of saturation, unbalance, or excessive disruption of the users, and minimising the reply times.

More generally, the number of participants is unlimited. A participant can dispatch an original information item, via one of the operating interfaces. This original information item is then passed on to one or more other participants selected intelligently by analysis of the original information sent, of the archive of information items sent by the various participants, and of specific criteria. A virtual round table is then formed, around which the participants exchange information items.

The system of the invention automatically manages the original information and the return information. It stores the information, and selects and manages the participants.

Other characteristics and advantages of the invention will appear more clearly and more fully on reading the description that follows of the preferred implementation and application variants, which are given by way of non-limiting examples and with reference to the appended drawings, in which:

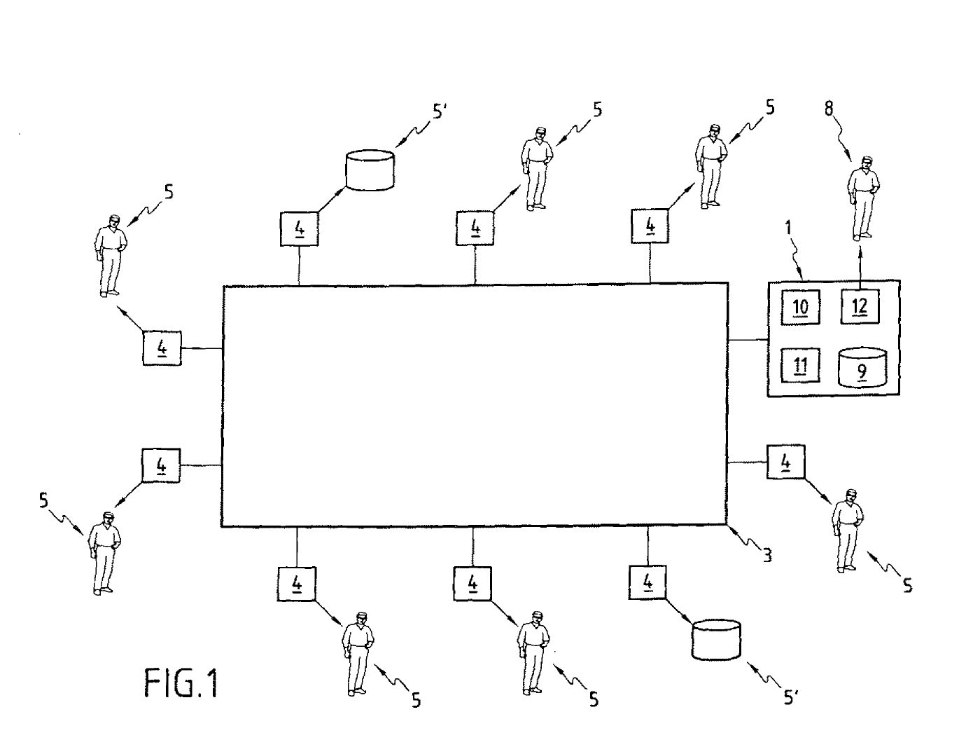

FIG. 1: schematically represents the system of the invention connected to a communication network,

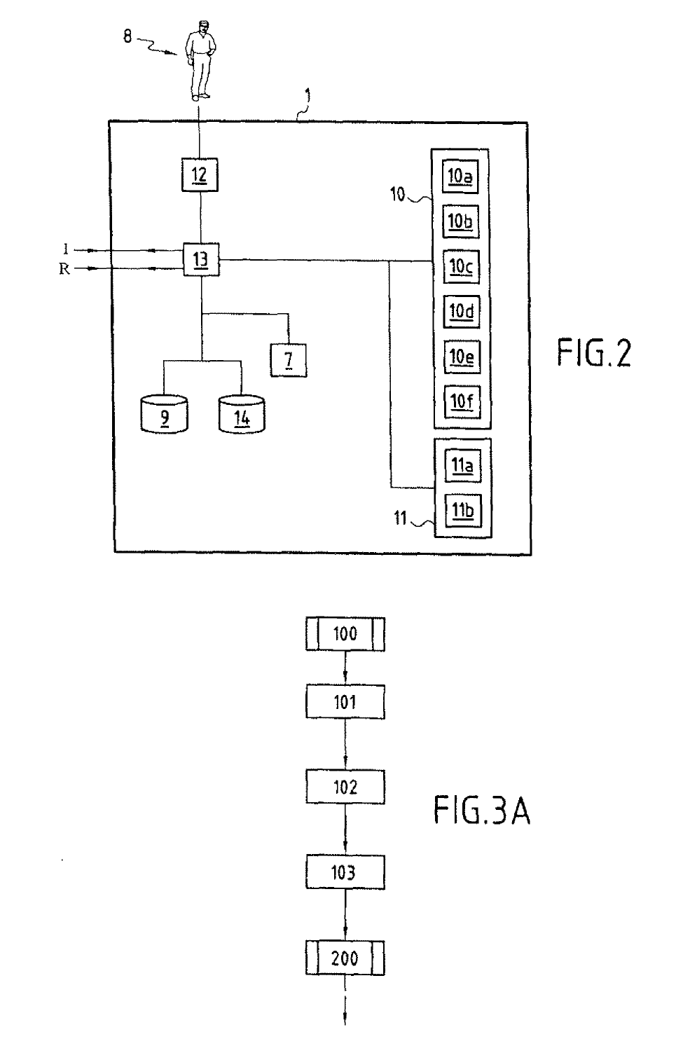

FIG. 2: schematically represents the details of the system of the invention.

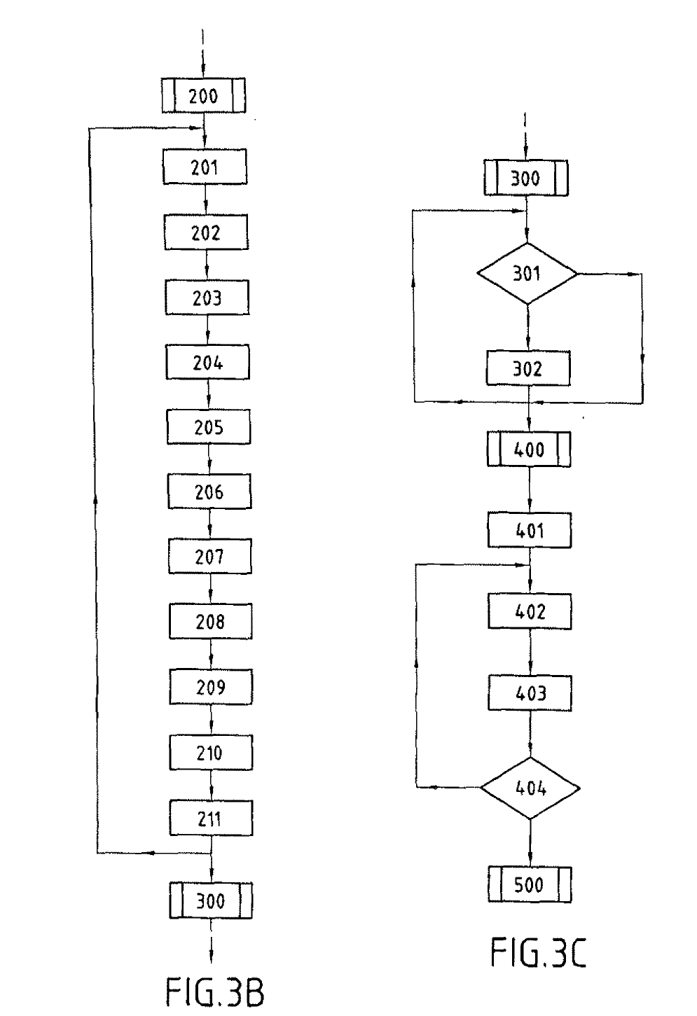

FIGS. 3a to 3c: schematically represent the method of the invention in its entirety.

FIG. 1 therefore schematically represents the system (1) of the invention, connected to a communication network (3). This communication network (3) can equally well be a computer network such as the Internet, an intranet or an extranet, for example. It can also concern any network grouping together any users (2, 5, 5′, 8) and communicating by a communication method proper to this network.

The system (1) of the invention preferably includes a server of the conventional type, which handles the incoming and outgoing communications, which also manages an archiving database (9), and which contains a means (10) for determining the match value between an original information item (1) made available by a sending participant (2) and the other participants (5, 5′), and a unit (11) for the selection of other participants (5, 5′). It also preferably includes an administration interface (12) allowing an administrator participant (8) to manage all of the system.

The sending participant (2) as well as the other participants (5, 5′) are connected to the communication network (3) via an interface (4). Each interface can be different and proper to the type of connection chosen by the participant in order to connect to the communication network (3). It can be a browser, for example. Together with the Internet and a communication modem installed in a computer in the case of a connection to the Internet. In the case of participants (5′) of the database type, the interface can include a means of translating an information item sent by the system (1) into a request accepted by the database (5′) and a means of translating the result of executing this request into an information item suitable for being sent in return to the system (1) via the communication network (3).

FIG. 2 schematically represents the details of the system (1) of the invention.

The system (1) includes a means (10) for determining the match value, and a selection unit (11), which are controlled by the engine (13) located functionally at the centre of the system. The engine (13) manages the reception and the dispatch of information items (I, R) coming from and going to a participant connected to the network. The system can be administered by an administrator participant (8) by means of an administration interface (12) connected to the engine (13). This engine (13) can be considered to be the operating system of the whole. In particular, it manages an archiving base (9) and one or more dynamic participation lists (7). The resource (10) for determining the match value includes a certain number of modules (10a,10b,10c,10d,10e) each with the role of calculating the value of a parameter or a given selection criterion.

The number of modules presented in FIG. 2 is only an example, and in no way limits the invention. The modular architecture in fact allows the addition or removal at will of the modules, like building bricks, or to activate or deactivate at will the modules present originally in the system. On receiving an original information item (T) the engine (13) inserts the identifier of the sender of this information item into a dynamic participation list, and then, for each of the participants stored in the base of the participants (14) other than the sending participant, calculates the match value of this participant with the original information item (I). To this end, it launches the execution of each of the modules (10a, 10b, 10c, 10d, 10e) and then sums the results, weighted by predefined weighting coefficients. The latter are stored by the engine (13) and can, for example, be modified by the administrator (8) via the administration interface (12). In this case, the standard weighting thus defined is applied to any original information item (I) received by the system. When all of the users have been divided into several groups or categories, the administrator can, where appropriate, define a standard weighting per group or category of users. These coefficients, or at least some of them, can, where appropriate, be specified directly by the sending participant of the original information item (I) at the moment of the sending this information. These coefficients are then dispatched with the original information item (I) to the engine (13). In this case, the specific weighting thus defined is applied only to the original information item (I) being processed, in an overwhelming manner in relation to the standard weighting.

Where appropriate, but not necessarily, all the participants having a match value thus calculated that is greater than a predetermined match threshold (also adjustable by the administrator and/or by the sender, in a similar manner to adjusting the weighting coefficients), are selected by the module (11a) of the selection unit (11).

From the reliability values determined by the aforementioned module (10d), a probability of no reply is calculated by the module (11b), and then the number of selected participants, considered in descending order of their respective match values, is minimised in order to avoid selecting more participants than necessary, while also keeping the probability of no reply below a certain threshold (itself adjustable just like the match threshold and/or the weighting coefficients).

Where appropriate, this selection unit (11) takes account of an additional parameter (also adjustable like the match threshold and/or the weighting coefficients and/or the threshold of probability of no reply) which is the maximum number of selectable participants.

It goes without saying that the above description of the system of the invention is a functional and non-structural description, and that it therefore does not limit the invention. Thus, for example, the separation between the resource (10), the unit (11) and the kernel (13) is not representative of a physical separation of these various components. On the other hand, the grouping together of these different components within the system (1) is functional only, and does not imply the necessity that all the components should be located at the same place in the communication network. These comments are naturally also valid for the archiving base (9), the dynamic participation list (7), the participant base (14) or the administration interface (12). For the latter, the administrator participant can very well be connected to the network by means of any interface, at any place in the network, and thus can communicate appropriately with the engine (13) by means of a secure connection mechanism.

Determining the match value for a given participant will now be described in greater detail.

Rate of Use:

The match value is based firstly on the rate of use. The purpose of this criterion is to call upon a participant in proportion to its use of the system (number and frequency of the information items that it has exchanged). It is based on the mean transmission frequency of original information items by the participant during a given period, and the mean reception frequency of original information items during the same period. This period can be configured.

This allows the system to be balanced, and it then functions on the basis of reciprocity. Moreover, this allows the activity of the participants to be smoothed out over time. Thus, if a participant sends 10 original information items in a single day, it will not be selected so readily on 10 other occasions.

Expertise:

The match value can also be based on expertise. The expertise value of a participant can be the rate of correspondence between the content of the information items that it has exchanged and which is archived in the archiving base, and the content of the original information being processed. This value can be determined by semantic analysis.

This analysis first breaks down the content of the original information into a sequence of terms called the “word list”, from which it is possible, where appropriate, to delete certain “empty” words.

Next, this list can be lemmatised by gathering together the words contained in the list of most generic terms including, for example, the plurals (as in a dictionary entry). This optional operation is used to considerably reduce the volume of the data archived in the database and, as a consequence, the processing effected.

Then, the internal dictionary of the system is updated with this new list.

Then, a word notation operation is executed, based on the notion of thematic linkage between two words, the relevance of a word, the occurrence of a word, and the directional relevance of the thematic link-age.

A thematic linkage associates two distinct words. This association means that the two words have been used in the same exchanged information item. Thus, each of the words of an exchanged information item is linked to the other words of this information item. Between any two distinct words, there can exist only a single thematic linkage, but the latter is weighted. The weight of a thematic linkage between two words is determined by the number of information items exchanged containing these two words simultaneously. As a consequence, the weight of a thematic linkage between two words is always between 0 and the total number of information items exchanged. Moreover, each word can be linked to each of the other words present in the internal dictionary.

From the notion of thematic linkage, it is possible to determine the relevance of the words. In fact, a word that is linked thematically to few others is more relevant, therefore much more meaningful to the system than a word that is linked thematically to all the others.

With each word is also associated a value equal to the number of distinct information items exchanged in which this word is used. This value is called the “occurrence” of the word. In general, a commonly used word will have a high occurrence.

The directional relevance of the thematic linkage from i to j is the value determined by the relevance of i multiplied by the weight of the thematic linkage between i and j, and divided by the occurrence of i.

Each term of the word list can then be scored. This score distinguishes the word within the other terms of the list. It aims to exclude “off-subject” words and, reciprocally, to favour the more important words, that is the key words of the context determined by all the words in the list. This score is the average of the directional relevances of the word to the other words multiplied by the relevance of the word.

Finally, an optional semantic extension stage can be executed, the aim of which is to extend the original list by incorporating into it the other words of the vocabulary register processed. To this end, to the original “word list” are added all of the terms having a thematic linkage with the words of the original exchanged information item. Each of these words gets a score determined by the score of the word in the original list to which it is linked, multiplied by the directional relevance of the thematic linkage of the word in the original list with which it is linked, to the word of the extended vocabulary.

From this semantic analysis, and with the aim of selecting the best possible participants in relation to the “word list”, the system studies the use of these terms by the various participants, basing its action on the notion of obsolescence criteria in order to allow for the fact that the areas of expertise change over time, since some are created while others disappear for lack of use, for example.

To this end, it is possible to reduce the analysis window so as to include only the messages exchanged during the last x months, in a manner that is rigid (immediate deletion of the obsolete expertise) or progressive sidelining of the obsolete expertise). For each participant/word pair, the system assigns an obsolescence coefficient of between 0 and 1, which is dependent on the date of last use of the word by the participant.

The expertise is then first scored in relation to the information items sent. This score is obtained using the sum of the scores obtained by the words used by the participant, each score being weighted by the obsolescence coefficients proper to the participant-word pair for each of the words, all in relation to the sum of these notes not weighted by their respective obsolescence coefficients.

Next, where appropriate, expertise can be scored in relation to the pages visited. By pages visited is meant, for example but not exclusively, the discussion threads read by a participant over time, or more generally the “Web pages” (product sheets, press articles or forms, for example) consulted over time. The content of these visited pages can be distinguished from information consulted (C).

One finally arrives at the overall expertise value, which is a veritable image of the expertise of each of the participants in relation to the original information sent, by summing the two previous expertise scores (and normalising them to 100 where appropriate).

The following is an imaginary example of a semantic analysis operating script.

Stage 0: Original information
“What is the recipe for pancakes, please?”
Stage 1, Breakdown of the information:
“word list”—What, is, the, recipe, for, pancakes, please
Stage 2: Deletion of “empty” words
“word list” is, recipe, pancakes

### Stage 3: Lemmatisation

“word list,”/Be, Recipe, Pancake
Stage 4: Extension of the internal dictionary
Stage 5: Scoring the words on the list

| Word | Score |
|---|---|
| Be | 0.00253 |
| Recipe | 0.51275 |
| Pancake | 0.73125 |

Stage 6: Semantic extension

| Word | Score |
|---|---|
| Be | 0.00253 |
| Recipe | 0.51275 |
| Pancake | 0.73125 |
| Kitchen | 0.50331 |
| Ingredient | 0.45012 |
| Butter | 0.21923 |
| Flour | 0.34012 |
| Egg | 0.28653 |
| etc . . . | |

Stage 7: notation participants

| Participant | Score |
|---|---|
| User156 | 76.54 |
| User25 | 55.23 |
| User3024 | 51.12 |
| User1158 | 47.32 |
| etc . . . | |

Alternatively, the expertise score in relation to the pages visited, that is to the discussion threads read by a participant over time, as mentioned above, can receive an independent score corresponding to an independent criterion, which we will call passive expertise (linked to the consultation of information), as opposed to active expertise (linked to the dispatch of information) which will then be the subject of another independent criterion. The respective values of these two expertise scores can be calculated separately, on the basis respectively of the information items sent and received (I, R) for the active expertise, and information consulted (C) for the passive expertise, following the same method, or a different method for each.

Availability:

This criterion can also be used to calculate the match value. Its value, for a given participant, can then be the probability that this participant is liable to send a return information item at the moment following the sending of an original information item. To this end, it is possible to take account of the times at which the participant is connected to the system, and also of the times at which he has already sent original information items and/or return information items.

The availability value of all the participants connected at the moment of sending an original information item, therefore including that of the participant sending this original information, is maximum of course (equal to 100).

The availability value of a participant sending an original information item is always maximum of course (equal to 100).

An unconnected participant has its availability value analysed in a rolling time window covering a predetermined number (x) of weeks (configurable where necessary). For each day during the last x weeks, it is possible to use a graph of the participation periods. This graph represents the connection periods of the participant, and the different exchanges of information effected (original information items and return information items are separated).

A connection period can be represented by a trapezium-shaped graph, with a small base representing the actual connection period, a wide base used to incorporate a progressive migration to a certain width, and a height representing the magnitude of the event.

An information exchange (original information item or return information item) can also be represented by a trapezium-shaped graph, the small base representing an arbitrary period (5 minutes for example), with the right-hand limit of the small base representing the date of the event, the wide base being used to incorporate a progressive migration to a certain width, and the height representing the magnitude of the event.

In order to be able to modulate the magnitude of one event in relation to another, it is possible to specify the height of each representation (connection period, original information item or return information item) by means of 3 parameters valued at between 0 and 1.

In order to obtain an availability value, different existing graphs within the temporal window are superimposed.

In order to favour the recent behaviour of the participant in relation to its earlier behaviour, each graph is assigned a weight of between 0 and 1. The most recent graph has a weight of 1.

All of these superimposed graphs form a function called the “availability function” only the envelope of which is important (i.e. the maximum value of the function obtained).

In order to obtain the availability value of a participant at a given instant t, it then suffices to read, on the graph of the study window, the value of the “availability function” at this same instant, and to multiply it by 100.

Calculation of the “availability function” can prove to be relatively important since the number of profiles of participants to be analysed is capable of growing very rapidly. From this point, execution of the calculation can take place periodically (every 24 hours, for example).

Satisfaction of the Community Regarding a Participant:

This additional criterion can also be used. Its value can then be determined by the various participants of the system. In fact, each participant is able to score the return information items that it has received. This score is the measure of its satisfaction in relation to the return information obtained, where this satisfaction takes account of many personal criteria such as the added value of the return information, the friendliness of the participant, the time taken, etc.

When the participant gets a return information item that suits it, it is able to validate it.

The overall score, for a given participant, can be calculated as the average of all the scores that it has received over a predetermined period.

Time Taken to Reply:

This other possible criterion for calculation of the match value, is based on the responsiveness of the participant. It therefore takes account of the average of the times taken to reply smoothed out over the last x weeks. The objective of the smoothing is to allow progressive deletion of the effects of particular events.

Proximity:

This criterion can be used to assess the physical distance separating two participants, or separating a participant and given geographical point. The shorter this distance, the higher the proximity score.

Courtesy:

This other optional criterion can be used to assign a score in accordance with the vocabulary register of the participant. The more the participant uses a courteous vocabulary that approaches that of the sender of the original information, the higher his score. The objective of this criterion is to bring into contact the participants having the same level of courtesy (the use of polite terminology, etc.). Calculation of its value can be based upon a specific semantic analysis employed by the same semantic analysis engine as that used to calculate the expertise value.

Affinity of Centres of Interest:

The affinity criterion can be used to assign a score as a function of the centres of interest of the participant in relation to those of the sending participant of the original information. Even if the subject of the original information concerns the precise area, the objective is to attribute a high score to the participants having the same centres of interest as the sending participant of the original information. The aim is to bring into contact participants that share the same centres of interest and thus to favour exchanges of interest to each other. This score can be determined by a specific semantic analysis, employed by the same semantic analysis engine as that used to calculate the expertise value.

Affinity of Relatedness:

This optional criterion is used to attribute a score to the participant in accordance with its level of relations with the sending participant of the original information item. To this end, the system is based on the friends lists (include the participants with whom one wishes to exchange information items as a priority) and black lists (that include the participants with whom one does not wish to exchange information) determined by the participants, and on the notion of friendly distance. As a consequence, the engine will never relay the question of a user to an expert appearing on his “black list”.

The notion of friendly distance is based on the saying “the friends of my friends are my friends”. In order to determine this coefficient, it is possible to recursively analyse the friends list of the sending participant of the original information item, and so on.

Affinity of Knowledge:

This optional criterion is determined in accordance with the level of interaction. In fact, all the participants having interacted directly during an information exchange with the sending participant of the original information, have a maximum knowledge affinity, equal to 1 for example. Next, those having interacted with the preceding participants have a knowledge affinity value that is less than the maximum value, equal to ½ for example, and so on.

Reliability:

The value of this criterion is based on the number of original information items received and the number of return information items sent by the participant.

It is possible, where appropriate, to also calculate the notion of reliability in relation to the area. It is then deduced, in the context of the area concerned, from the number of original information items received and the number of return information items sent by the participant.

Match Value:

The match value of each participant can then be determined, by weighting the criteria determined previously, that is by calculating the weighted average of these criteria.

Of course, a weighting equal to 0 for a given criterion allows this criterion to be deactivated so that no account is taken of it.

It is possible, where appropriate, to pre-select the participants whose match value is greater than a given threshold.

Finally, it is possible to determine the probability of the participant sending a return information item.

The objective sought by the calculation and the use of the probability of reply (or non-reply) is to reduce the chances of not replying, following the sending of an original information item, to a predetermined threshold σ (σ=5% for example). To this end, a minimum number of participants having respectively obtained the highest scores, and therefore after sorting these participants into descending order of their respective match values, is selected by the system (from 1 at the minimum to β at the maximum), so that the probability of no reply is less than σ. The method of calculation can be as follows:
the probability of no reply (P) is initialised to 1, and the number of selected participants (N) to 0,
for all the participants (where appropriate having obtained a match value greater than the predetermined threshold), starting with the one having obtained the highest reliability value:
   the probability of no reply of the participant is calculated (equal to 1 minus the reliability value),
   this is multiplied by P,
   the result becomes the new value of P,
   selection of the participant is confirmed,
   N is incremented by 1
   if N is equal to the maximum number of selectable participants (β) (configurable), or if P is less than the threshold σ, or if N is equal to the number of participants present in the system, then the calculation is ended.

In the case where the same reliability score has been attributed by the system to several participants, it is possible to envisage “un-sharing” them in accordance with certain other criteria such as the time taken to reply, for example.

In addition, these reliability criteria (general or in relation to the area) can, where appropriate, be integrated directly into calculation of the match value, in the same way as the other criteria, as explained above.

The method of the invention will now be explained in greater detail with reference to FIGS. 3a to 3c.

In the method of the invention, a participant sends an original information item to the system, which then automatically selects the other participant or participants best suited to send a return information item (the participants known as “experts”).

In an advanced method or implementation, the participant can configure the operation of the system more precisely. It is possible, for example, to force certain of its contacts as recipients of the original information. It can also specify the urgent character of the original information. With this information, the engine assigns more or less importance, for example, to the availability criterion of the participants to be contacted. The participant can also specify, where appropriate, the geographical zone of the potential recipients, with the aim of reaching the participants closest to it, for example, or located in a given country.

When a participant receives an original information item, it has the option of sending an information item in return. The original information and each return information item are added to a dynamic participation list, rendered visible to all the participants called upon. It is thus possible to create a form of discussion between participants.

More precisely, with reference to FIG. 3a, the first part (100) of the method of the invention includes a stage (101) for the making available of an original information item by a first who sends this information item to the system. Stage (101) is followed by the stage (102) for archiving of the original information previously sent into an archiving database, associated with the identifier of the sender. Then, at stage (103), a dynamic participation list is created, in which the identifier of the sender is inserted.

The next part (200) of the method concerns determining the match value of each of the other participants, and will now be explained with reference to FIG. 3b.

This second part (200) of the method includes a loop around all of these other participants. This loop itself includes a series of stages (201 to 210) in which the various selection criterion values are calculated for the participant being processed. These are the rate of use as mentioned previously, to which can be added some of the values also mentioned previously such as expertise, availability, satisfaction, time taken to reply, proximity, courtesy, affinity of centres of interest, affinity of relatedness, affinity of knowledge, reliability, etc. . . . ), leading to the presence in FIG. 3b of these 10 stages (201 to 210). However, this number of stages is given only by way of an example, since, as explained previously, some of these criteria are optional and others can be added, activated or de-activated, using the modular architecture of the system employing the method. For this reason, the number of stages can be either more than or less than the number given in this detailed description as an example.

When all the respective values of each of the selection criterion have thus been calculated, for each other participant, the match value of the said participant is determined at stage (211) as the weighted average of the values previously calculated. It will be understood that the deactivation of a given criterion can be achieved by configuring the weighting coefficient of this criterion to 0. it is also possible, in this case (deactivation of a selection criterion by setting its weighting coefficient to 0) and in order to optimise the method, to perform a test on the weighting coefficient prior to calculating the value of each of the selection criteria. If the coefficient is at 0, then the calculation is not performed and the value of the criterion is set to 0.

When determination of the match value has thus been effected for each of the other participants, the method starts the third part (300), which concerns selection of the participants, which will now be explained with reference to FIG. 3c.

This third part (300) includes a loop around each of the selectable participants. This loop can itself include a test (301) to determine if the match value of the participant being processed is greater than the predetermined match threshold. If this is the case, the participant is then selected at stage (302). If the test (301) on the match value is negative, the following stages are not executed of course. This third part (300) of the method continues to loop until the list of participants has been exhausted.

From the selected participants in the third part (300) of the method, a fourth, filtering part (400) is executed, which concerns minimising the probability of no reply as described previously, and which will now be explained, also with reference to FIG. 3c.

This fourth part (400) includes a loop around each of the selected participants in the third part (300) of the method, considered in descending order of their respective match values. This loop is preceded by a stage (401) for initialising the probability of no reply (P) to 1, and of the number of selected participants (N) to 0.

The said loop includes a first stage (402) for calculating the probability of no reply of the participant being processed (which we will take as equal to 1 minus the reliability value determined at stage 303). Also during this stage (402), the value of P is modified so that it is equal to its previous value multiplied by the probability of no reply of the participant being processed.

At stage (403), the selection of the participant being processed and confirmed, and the value of the number of selected participants (N) is incremented by 1. This stage (403) is followed by the test (404) to determine if N is equal to the maximum number of selectable participants less 1 (since the sending participant cannot be selected), or if the value of P is less than the predetermined threshold of probability of no reply, or if N is equal to the number of participants present in the system. If this test is positive, the loop stops and selection is ended at stage 500. Otherwise, the loop continues on the other participants, considered in descending order of their respective match values.

This stage (500) is in fact a fifth part of the method, and includes several staves not shown in FIG. 5c. It begins with the sending, by the system, of the original information item to all the selected participants, and archiving, in the archiving base, of this information associated respectively with the identifiers of all these participants. From then on, one or more of the selected participants can reply by sending a return information item to the system. The system then archives the return information in the archiving base, associated respectively with the identifier of the original participant and of the one that replied, and then inserts the identifier of the one who replied into the dynamic participation list. Where appropriate, this insertion can depend upon the category to which this participant belongs. If, for example, the participant is of the database type, it will not be inserted into this dynamic participation list. Where appropriate, the participant can specify whether or not it wishes to be inserted into this dynamic participation list. Then the system transmits the return information item to the original participant. The system can also transmit this return information item to any other participant appearing on the dynamic participation list (and then archive the said return information in the archiving base associated respectively with the identifiers of these other participants). In this last case, the fact, for example, of not having inserted the participants of the database type into the participation list is used to prevent the transmission to a database participant of a return information item that is untranslatable into a request that can be accepted by the database.

It should be remembered that all of the above description is given by way of an example only, and does not limit the invention as has been stated throughout this description.

1. An information management system in a communication network connecting a collection of participants who can be senders and/or recipients of information, including:
a stage for the making available of at least one original information item by at least one first participant sender of information by means of an interface, with the original information item being liable to be received by one or more other participants,
a stage, for each of the other participants, for determining a match value between the original information item and the other participant,
a stage for selecting at least one of the other participants, as a function of the sa match values for each of these so other participants,
a stage for sending the original information item to the other participants selected during the election stage,
wherein the stage for determining a match value includes a stage for determining the rate of use of the participant.

2. An information management system according to claim 1, further comprising a stage for the creation of a dynamic participation list including the participant sender of the original information item.

3. An information management system according to claim 1, wherein the sending stage is followed by a stage for the sending by at least one of the other selected participants of at least one return information item to the sending participant, by means of an interface.

4. An information management system according to claim 3, wherein each other selected participant that sent at least one return information item to the sending participant, is inserted into the dynamic participation list.

5. An information management system according to claim 4, wherein each return information item sent by any of the other selected participants to the sending participant, and also sent to all the other participants belonging to the dynamic participation list.

6. An information management system according to claim 1, wherein each of the information items is archived in an information base, being associated with the respective identifiers of the sending participant and of receiving participant or participants.

7. An information management system according to claim 1, wherein each of the information items consulted by the sending participant and receiving participant or participants during a given period, is archived in the information base, being associated with the respective identifiers of this sending participant and of this or of these receiving participants.

8. An information management system according to claim 1, wherein the stage for determining the rate of use, also includes determining the mean frequency of the making available of the original information item by the other participant during a predetermined period, and determining the mean reception frequency of the original information item by the other participant during a predetermined period.

9. An information management system according to claim 1, wherein the stage for determining the said match value includes, in addition to the stage for determining the rate of use, at least one stage for determining the value of at least one other selection criterion.

10. An information management system according to claim 9, wherein the stage for determining the match value includes, in addition to the stage for determining the rate of use, at least one stage for determining an expertise and/or availability and/or satisfaction and/or reliability value.

11. An information management system according to claim 10, wherein since the stage for determining the match value includes, in addition to the stage for determining the rate of use, at least one stage for determining an expertise value, then the expertise value is an active expertise value.

12. An information management system according to claim 10, wherein, since the stage for determining the match value includes, in addition to the stage for determining the rate of use, at least one stage for determining an expertise value, then the so expertise value is a passive expertise value.

13. An information management system according to claim 1, wherein each of the selection criterion values is assigned a weighting coefficient.

14. An information management system according to claim 1, wherein the match value is the average of the respective values of the selection criteria, weighted by the weighting coefficients.

15. An information management system according to claim 1, wherein the selection stage includes a stage for the selection of other participants for which the match value is greater than a predetermined match threshold.

16. An information management system according to claim 10, wherein the reliability value determined at the stage for determining a reliability value, is a function of the number of return information items sent and of the number of original information items received.

17. An information management system according to claim 10, wherein the selection stage includes:
a stage for calculating the probability of no reply from the reliability values of each of the other selected participants and considered in descending order of their respective match values,
and a stage for minimising the number of these other selected participants and considered in descending order of their respective match values, during which the minimum number of these other selected participants is retained so that the probability of no reply is less than a predetermined threshold.

18. An information management system according to claim 1, further comprising a stage for adjusting the parameters for determining the match and selection value, by the sending participant of the original information item and/or by an administrator participant.

19. An information management system according to claim 18, wherein the parameters for determining the match and selection value include the threshold of probability of no reply and/or the maximum number of the other selectable participants and/or one or more of the weighting coefficients and/or the match threshold.

20. An information management system according to claim 10, wherein determining the said expertise value of the said other participant includes:
a semantic analysis of the original information item made available by the sending participant,
a comparison of the semantic analysis with the contextual analysis of the information item and/or return information items and/or information items archived in the information base and associated with the other participant.

21. A computer-readable storage medium, on which is stored a sequence of instructions which, when it is executed by a computer system, allows the computer system to implement the information management system according to claim 1.

22. An intelligent interactive system for the management of information in a communication network connecting, by means of interfaces, a collection of participants who can be senders and/or recipients of information, and employing the information management system according to claim 1.

23. A system according to claim 22, further comprising:
a means for determining the match value between an original information item, made available by a given sending participant, and another given participant,
a unit for the selection of at least one other participant as a function of the match values determined for each of the other participants by the resource for determining the match value,
wherein the means of determining the sa match value includes at least one module for determining the rate of use of the other participant.

24. A system according to claim 23, wherein the resource for determining the match value includes, in addition to the module for determining the rate of use of the other participant, at least one module for determining the value of at least one other selection criterion

25. An information management system according to claim 13, wherein the selection stage includes:
a stage for calculating the probability of no reply from the reliability values of each of the other selected participants and considered in descending order of their respective match values,
and a stage for minimising the number of these other selected participants and considered in descending order of their respective match values, during which the minimum number of these other selected participants is retained so that the probability of no reply is less than a predetermined threshold.

26. An information management system according to claim 14, wherein the selection stage includes:
a stage for calculating the probability of no reply from the reliability values of each of the other selected participants and considered in descending order of their respective match values,
and a stage for minimising the number of these other selected participants and considered in descending order of their respective match values, during which the minimum number of these other selected participants is retained so that the probability of no reply is less than a predetermined threshold.

27. An information management system according to claim 15, wherein the selection stage includes:
a stage for calculating the probability of no reply from the reliability values of each of the other selected participants and considered in descending order of their respective match values,
and a stage for minimising the number of these other selected participants and considered in descending order of their respective match values, during which the minimum number of these other selected participants is retained so that the probability of no reply is less than a predetermined threshold.

28. An information management system according to claim 16, wherein the selection stage includes:
a stage for calculating the probability of no reply from the reliability values of each of the other selected participants and considered in descending order of their respective match values,
and a stage for minimising the number of these other selected participants and considered in descending order of their respective match values, during which the minimum number of these other selected participants is retained so that the probability of no reply is less than a predetermined threshold.
